(19) United States
(12) Patent Application Publication
(10) Pub. No.: US 2025/0067767 A1
(43) Pub. Date: Feb. 27, 2025

(54) AIRCRAFT AIRFLOW DATA PROBE HAVING INTEGRATED CALIBRATION DATA AND AIR DATA COMPUTER CONFIGURED TO VALIDATE THE AIRCRAFT AIRFLOW DATA PROBE

(71) Applicant: AEROSONIC, LLC, Clearwater, FL (US)

(72) Inventors: Randy LANG, New Port Richey, FL (US); Tan LE, Pinellas Park, FL (US); Jack KRAMER, Saint Petersburg, FL (US)

(21) Appl. No.: 18/814,415

(22) Filed: Aug. 23, 2024

Related U.S. Application Data
(60) Provisional application No. 63/578,837, filed on Aug. 25, 2023.

(51) Int. Cl. G01P 21/00; G01P 1/02; G01P 5/16

(52) U.S. Cl. CPC G01P 21/00; G01P 1/026; G01P 5/16

(57) ABSTRACT

An aircraft airflow sensor includes one or more pitot inlets, ports, and/or static ports and a calibration data memory physically storing calibration data with the aircraft airflow sensor probe. The aircraft airflow sensor moreover includes where the calibration data is configured to be implemented in an air data computer (ADC).

### CROSS-REFERENCE TO RELATED APPLICATIONS

This application claims the benefit from U.S. Provisional Application No. 63/578,837 filed on Aug. 25, 2023, which is hereby incorporated by reference in its entirety for all purposes as if fully set forth herein.

### FIELD OF THE DISCLOSURE

The disclosure relates to an aircraft airflow data probe having integrated calibration data. Additionally, the disclosure relates to a process of implementing an aircraft airflow data probe having integrated calibration data. The disclosure additionally relates to an air data computer configured to validate an aircraft airflow data probe. Further, the disclosure is directed to a process of implementing an air data computer configured to validate an aircraft airflow data probe.

### BACKGROUND OF THE DISCLOSURE

Aircraft airflow data probes containing computing electronics, often referred to as “smart” aircraft airflow data probes, have the ability of applying software corrections to outputs to bolster system accuracy. The software corrections that are applied are sourced from calibration data that is stored in memory within an Air Data Computer (ADC).

For federated Air Data Systems (ADS), where the ADC and the aircraft airflow data probe are not collocated, for example within a same Line-Replaceable Unit (LRU), the stored calibration data is not physically bound to the aircraft airflow data probe. Accordingly, there is a possible risk to “mate” a probe to an ADC that has the calibration data for a different probe stored in memory. This calibration data mismatch would be undetectable by the system and could result in misleading, erroneous, and/or the like data outputs from the ADS and/or the ADC.

Accordingly, what is needed is an aircraft airflow data probe, Air Data System, and/or Air Data Computer configured to reduce a likelihood of a calibration data mismatch.

### SUMMARY OF THE DISCLOSURE

The disclosure is directed to a method for storing calibration data within an aircraft airflow data probe and the ability for a remotely connected Air Data Computer (ADC) to automatically validate that the correct calibration data is loaded into the ADC without human intervention. The aerospace market values air data system architectures that reduce and/or eliminate the risk of human error, reduce the level of human labor involved in normal operating procedures, reduce the level of human labor involved in maintenance procedures, and/or the like.

The method by which calibration data is typically being managed within the air data system opened the door for human error and the disclosed devices and/or automated probe validation processes would substantially eliminate the opportunity for human error and allow for replacement of aircraft airflow data probes to occur without touching and/or interacting with the Air Data Computer (ADC). Further, the disclosed devices and/or processes may reduce the need for and/or eliminate the need for on aircraft programming of the calibration data into the Air Data Computer (ADC).

The processes of the disclosure include a method for storing calibration data within an aircraft airflow data probe and the ability for a remotely connected Air Data Computer (ADC) to automatically validate that the correct calibration data is loaded into the ADC without human intervention.

The aircraft airflow data probe assembly may contain a memory that may be programmed with the calibration data. In aspects, the memory may be implemented as an electronically erasable and programmable read-only memory (EEPROM), that may be programmed with the calibration data, for example during acceptance testing at test facilities and/or the like.

Thereafter, the ADC may download and/or otherwise receive the calibration data from the aircraft airflow data probe. For example, the ADC may download the calibration data from the aircraft airflow data probe upon power up during system initialization. This technical solution may also simplify maintenance functions in the field since the ADC may not have to be removed and replaced each time a probe is replaced, recalibrated, and/or the like.

The memory may be hosted on an application interface structure such as a printed circuit board (PCB) that contains components and circuitry that may extend the transmission distance of communications coming from a communication interface, such as a serial peripheral interface (SPI). The extended transmission distance may be required to accommodate remote installations, such as wing-tip probe installations. The components to extend the transmission distance are not required when the aircraft airflow data probe and the ADC are a single unit.

In aspects, the circuit may also provide lightning isolation between the aircraft airflow data probe and the ADC. However, in other aspects, the circuit may be implemented without lightning isolation.

The disclosed device and process may provide a plug and play solution to the Aerospace market (military UAVs, business jets, regional jets, and/or the like). The solution simplifies the maintenance processes, repair processes, and/or the like and makes the disclosed solution less costly to an aircraft operator.

The disclosed device and process may allow an operator to remove a probe from an aircraft and install a new probe without having to manually load the new probe's calibration data into the Air Data Computer (ADC), having to remove the ADC from the aircraft, and/or the like. Typically, there may be multiple aircraft airflow data probes and ADCs on each aircraft, which compounds potential human error. The disclosed device and process may reduce and/or eliminate the potential for human error.

The customer may not be required to maintain the ADC and probe as a matched set. Any probe may be mated with any ADC at installation, even though a unique calibration may be required for each probe to meet the specified accuracy. Further, the disclosed device and/or process may reduce and/or eliminate the need to pair aircraft airflow data probes with ADCs coming out of a factory, a repair station, and/or the like.

In one general aspect, an aircraft airflow sensor may include calibration data physically stored within the aircraft airflow sensor probe.

In one aspect, an aircraft airflow sensor includes one or more pitot inlets, ports, and/or static ports. The aircraft airflow sensor in addition includes a calibration data memory physically storing calibration data with the aircraft airflow sensor probe. The aircraft airflow sensor moreover includes where the calibration data is configured to be implemented in an air data computer (ADC).

In one aspect, a process includes providing one or more pitot inlets, ports, and/or static ports. The process in addition includes physically storing calibration data with the aircraft airflow sensor probe in a calibration data memory. The process moreover includes where the calibration data is configured to be implemented in an air data computer (ADC).

There has thus been outlined, rather broadly, certain aspects of the disclosure in order that the detailed description thereof herein may be better understood, and in order that the present contribution to the art may be better appreciated. There are, of course, additional aspects of the disclosure that will be described below and which will form the subject matter of the claims appended hereto.

In this respect, before explaining at least one aspect of the disclosure in detail, it is to be understood that the disclosure is not limited in its application to the details of construction and to the arrangements of the components set forth in the following description or illustrated in the drawings. The disclosure is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods, and systems for carrying out the several purposes of the disclosure. It is important, therefore, that the claims be regarded as including such equivalent constructions insofar as they do not depart from the spirit and scope of the disclosure.

### BRIEF DESCRIPTION OF THE DRAWINGS

FIG. 1 illustrates a schematic view of an aircraft system having an aircraft airflow sensor probe and an air data computer (ADC) according to the disclosure.

FIG. 2 illustrates another schematic view of an aircraft system having an aircraft airflow sensor probe and an air data computer (ADC) according to the disclosure.

FIG. 3 illustrates another schematic view of an aircraft system having an aircraft airflow sensor probe and an air data computer (ADC) according to the disclosure.

FIG. 4 illustrates a partial internal view of the aircraft airflow sensor probe according to aspects of the disclosure.

FIG. 5 illustrates a schematic of the aircraft system according to aspects of the disclosure.

FIG. 6 illustrates partial exemplary internal view of the aircraft airflow sensor probe according to aspects of the disclosure.

FIG. 7 illustrates another partial exemplary internal view of the aircraft airflow sensor probe according to aspects of the disclosure.

FIG. 8 illustrates another partial exemplary internal view of the aircraft airflow sensor probe according to aspects of the disclosure.

FIG. 9 illustrates another partial exemplary internal view of the aircraft airflow sensor probe according to aspects of the disclosure.

FIG. 10 illustrates a schematic of the aircraft system including the aircraft airflow sensor probe and the air data computer (ADC) according to aspects of the disclosure.

FIG. 11 illustrates a process of implementing an aircraft airflow sensor probe and air data computer (ADC) according to the disclosure.

### DETAILED DESCRIPTION

The disclosure will now be described with reference to the drawing figures, in which like reference numerals refer to like parts throughout. Aspects of the disclosure advantageously provide an aircraft airflow sensor having integrated pressure transducers.

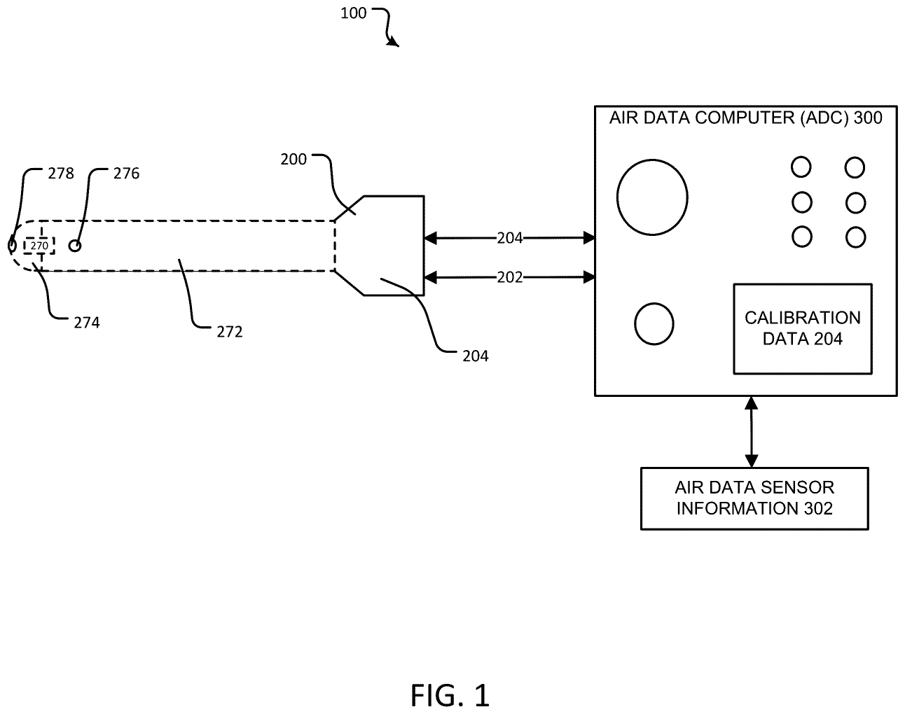

FIG. 1 illustrates a schematic view of an aircraft system having an aircraft airflow sensor probe and an air data computer (ADC) according to the disclosure.

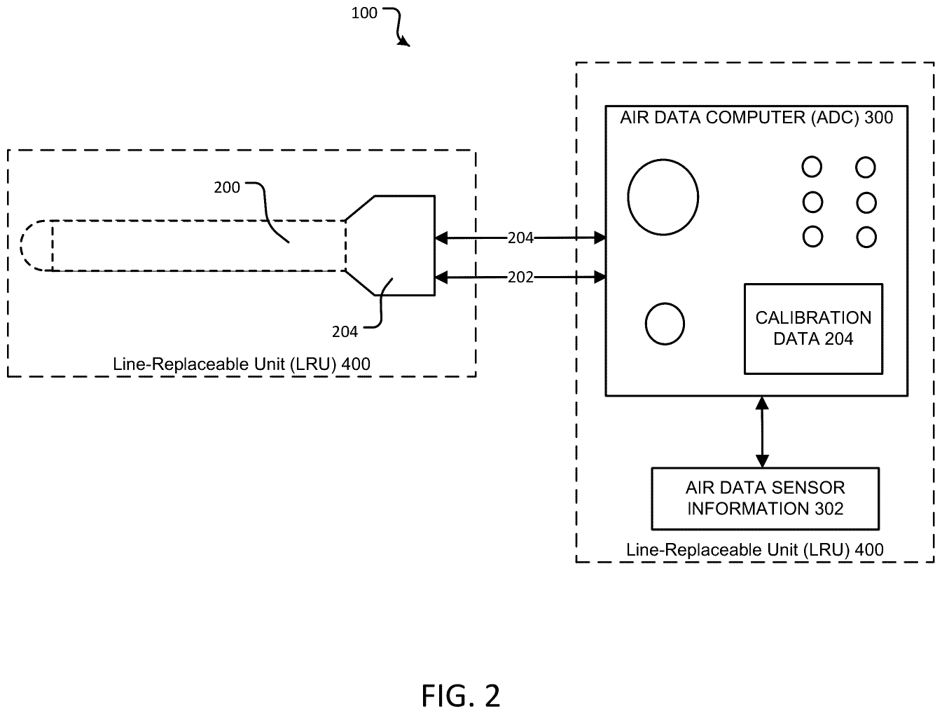

FIG. 2 illustrates another schematic view of an aircraft system having an aircraft airflow sensor probe and an air data computer (ADC) according to the disclosure.

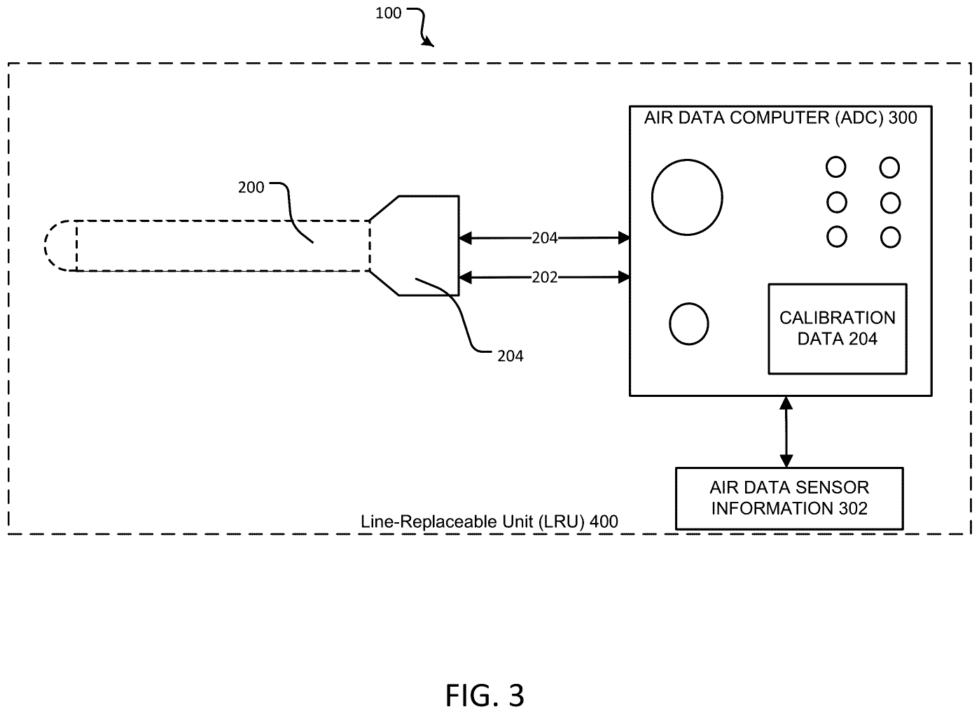

FIG. 3 illustrates another schematic view of an aircraft system having an aircraft airflow sensor probe and an air data computer (ADC) according to the disclosure.

In particular, FIG. 1 illustrates a schematic view of an aircraft system 100 having an aircraft airflow sensor probe 200 and an air data computer (ADC) 300 according to the disclosure. In aspects, the aircraft airflow sensor probe 200 may be an ogive shaped airflow sensor, a bullet shaped airflow sensor, a rounded shaped airflow sensor, a partially cylindrical shaped airflow sensor, a vane shaped airflow sensor, a cone-shaped airflow sensor, and/or the like. In aspects, the aircraft airflow sensor probe 200 may be a vane assembly that determines angle of attack by sensing a direction of local airflow, a rotatable airstream direction probe, and/or the like. In aspects, the aircraft airflow sensor probe 200 may have ridges and/or raised portions on a surface thereof.

Additionally, the aircraft airflow sensor probe 200 may include calibration data 204. In particular, the calibration data 204 may be physically stored with the aircraft airflow sensor probe 200 to ensure that throughout various implementations of the aircraft airflow sensor probe 200, the associated values of the calibration data 204 are always with the aircraft airflow sensor probe 200.

In aspects, the aircraft airflow sensor probe 200 includes a structure, a housing, components, and/or the like. In aspects, the calibration data 204 is on, attached to, or within the structure, the housing, the components, and/or the like of the aircraft airflow sensor probe 200. In aspects, the calibration data 204 may be configured to be integrated into the aircraft airflow sensor probe 200. In aspects, the calibration data 204 may be configured to be integrated into the structure, the housing, the components, and/or the like of the aircraft airflow sensor probe 200.

The calibration data 204 may be data to correlate certain collected air pressures and/or electrical signals generated from air pressures in and/or by the aircraft airflow sensor probe 200 that provide calibration adjustments to increase accuracy, repeatability, and/or the like for the various sensor readings from the aircraft airflow sensor probe 200. In aspects, the calibration data 204 of the aircraft airflow sensor probe 200 may be specific to a specific implementation of the aircraft airflow sensor probe 200. In other words, another implementation of the aircraft airflow sensor probe 200 is likely to have different corresponding values of the calibration data 204.

In aspects, the calibration data 204 of the aircraft airflow sensor probe 200 may be specific to a specific implementation of the aircraft that utilizes the aircraft airflow sensor probe 200. In other words, another aircraft implementing the aircraft airflow sensor probe 200 is likely to have different corresponding values of the calibration data 204.

In aspects, the calibration data 204 of the aircraft airflow sensor probe 200 may be specific to a specific implementation of the aircraft airflow sensor probe 200 and the calibration data 204 of the aircraft airflow sensor probe 200 may further be specific to a specific implementation of the aircraft that utilizes the aircraft airflow sensor probe 200. In other words, another implementation of the aircraft airflow sensor probe 200 and another aircraft implementing the aircraft airflow sensor probe 200 is likely to have different corresponding values of the calibration data 204.

In aspects, the calibration data 204 may be a series of calibration values arranged in a lookup table providing calibration amounts, offset amounts, and/or the like for the aircraft airflow sensor probe 200 and/or the aircraft. Additionally or alternatively, the calibration data 204 may be a series of constants, variables, and/or the like providing calibration amounts, offset amounts, and/or the like for the aircraft airflow sensor probe 200 and/or the aircraft. Additionally or alternatively, the calibration data 204 may be one or more polynomial functions including one or more constants, variables, and/or the like providing calibration amounts, offset amounts, and/or the like for the aircraft airflow sensor probe 200 and/or the aircraft.

In aspects, the calibration data 204 may include a serial number identifying the specific calibration data, identifying the specific calibration data of the unit that the calibration is associated with, identifying the specific calibration data with the associated implementation of the aircraft airflow sensor probe 200, identifying the specific calibration data with the aircraft airflow sensor probe 200, and/or the like. In this regard, the serial number may be used to ensure that the calibration data is appropriately associated with the particular implementation of the aircraft airflow sensor probe 200 and/or the aircraft.

In aspects, the calibration data 204, the aircraft airflow sensor probe 200, the air data computer (ADC) 300, and/or the like may include integrity checking mechanisms. In aspects, the integrity checking mechanisms may include devices, processes, functionality, and/or the like for cyclic redundancy check (CRC), forward error correction (FEC), channel coding, and/or the like for controlling errors in data storage, data transmission over unreliable or noisy communication channels, and/or the like.

The aircraft system 100 may be implemented as an Air Data System (ADS), a federated Air Data Systems (ADS), and/or the like. Further, the aircraft system 100 may be configured such that the aircraft airflow sensor probe 200, the air data computer (ADC) 300, and/or the like may be remotely connected, collocated, not collocated, physically separated, physically combined, distributed, and/or the like. In other words, the arrangement, location, various connections, and/or the like between components of the aircraft system 100 including the aircraft airflow sensor probe 200 and the air data computer (ADC) 300 may have any form and may be able to take advantage of the features described herein relating to implementation of the calibration data 204 with the aircraft airflow sensor probe 200.

In particular, the aircraft airflow sensor probe 200 provides the data readings 202 to the aircraft system 100 and/or the air data computer (ADC) 300. In particular, the aircraft airflow sensor probe 200 obtains the data readings 202 from at least one sensor 252. In aspects, the at least one sensor 252 may include one or more pitot inlets, ports, static ports, and/or the like. In aspects, the at least one sensor 252 may include one or more pitot inlets, ports, static ports, and/or the like to provide pneumatic pressure to the air data computer (ADC) 300. In aspects, the at least one sensor 252 may include one or more pressure transducers configured to measure pressure and provide electrical pressure signals to the air data computer (ADC) 300.

The data readings 202 may be actual air pressures collected from various ports on the aircraft airflow sensor probe 200 and provided to the air data computer (ADC) 300 and/or the aircraft system 100. In other aspects, the data readings 202 may be electrical signals generated from transducers based on air pressures collected from various ports on the aircraft airflow sensor probe 200; and the electrical signals being provided to the air data computer (ADC) 300 and/or the aircraft system 100.

In this regard, the calibration data 204 may be stored with the aircraft airflow sensor probe 200 separate from the air data computer (ADC) 300 and/or other components of the aircraft system 100. Accordingly, initial implementation of the aircraft airflow sensor probe 200 may include the calibration data 204 of the aircraft airflow sensor probe 200 being downloaded, transmitted, and/or provided to the air data computer (ADC) 300 and/or the aircraft system 100 to which the aircraft airflow sensor probe 200 is attached.

This process of the aircraft airflow sensor probe 200 storing the calibration data 204 and providing it to the air data computer (ADC) 300 ensures that the aircraft system 100 is implementing the appropriate values of the calibration data 204 for the aircraft airflow sensor probe 200 being used by the aircraft system 100 and/or the appropriate values of the calibration data 204 for aircraft implementing the aircraft airflow sensor probe 200.

Further, during operation of the aircraft system 100, the aircraft airflow sensor probe 200 may provide the data readings 202 to the air data computer (ADC) 300. Thereafter, the air data computer (ADC) 300 may utilize the calibration data 204 in conjunction with the data readings 202 in order to provide air data sensor information 302 having greater accuracy, repeatability, and/or the like to the aircraft system 100, the pilots, another aircraft system, and/or the like.

In this regard, the calibration data 204 may be specific to a particular implementation of the aircraft airflow sensor probe 200 and/or may be specific to a particular implementation of the aircraft. More specifically, implementations of the aircraft airflow sensor probe 200 may be tested in testing facilities and/or the like to ascertain and/or obtain a specific collection of the calibration data 204 for a particular implementation of the aircraft airflow sensor probe 200.

In aspects, the aircraft airflow sensor probe 200 may be configured to be mounted to an aircraft for measurement of various airflow characteristics and/or aircraft flight characteristics. In aspects, the aircraft airflow sensor probe 200 may include a probe 272, a probe tip 274, at least one first port 276, at least one second port 278, and/or the like. In aspects, the at least one first port 276, the at least one second port 278, and/or the like may be configured as angle of attack (AOA) measurement ports, angle of sideslip (AOS) measurement ports, static pressure measurement ports, a pitot pressure inlet port, and/or the like.

Further, the at least one first port 276 and/or the at least one second port 278 may be configured in conjunction with other components of the aircraft airflow sensor probe 200 to collect air to measure an angle of attack (AOA), an angle of sideslip (AOS), and/or the like various airflow characteristics and/or aircraft flight characteristics. In one aspect, the at least one second port 278 may be configured as a pitot pressure inlet. In aspects, the at least one first port 276 may be placed on the probe tip 274. In aspects, the at least one second port 278 may be placed on the probe tip 274. However, other configurations of the aircraft airflow sensor probe 200 may alternatively be implemented.

In aspects, the aircraft airflow sensor probe 200 may be an air data probe as described in U.S. patent application Ser. No. 18/742,875 filed Jun. 13, 2024 and incorporated by reference in its entirety. In aspects, the aircraft airflow sensor probe 200 may be a vane assembly that determines angle of attack by sensing a direction of local airflow as described in U.S. Pat. No. 11,029,326 B2 granted Jun. 8, 2021 and incorporated by reference in its entirety. In aspects, the aircraft airflow sensor probe 200 may be a rotatable airstream direction probe as described in U.S. Pat. No. 5,544,526 A granted Aug. 13, 1996 and incorporated by reference in its entirety.

Further, the aircraft airflow sensor probe 200 may include a heater 270 arranged within the probe tip 274 of the aircraft airflow sensor probe 200. The heater 270 is shown only schematically in FIG. 1. In one aspect, the heater 270 may be dual redundant, switching from a low-current, high-reliability, dual channel cooperative heating, to nominal current, single channel heating in the event of a heater failure. In response to a heater failure, the aircraft, pilots, a central maintenance system, a flight management system, and/or the like may be notified that a heater has failed and a maintenance action is needed. However, the heater 270 may be configured such that the aircraft airflow sensor probe 200 may be still at least partially operative and accordingly certified to fly in icing conditions even if only one channel is operational. Control of the heater 270 may be responsive to a processor, the aircraft, measurement circuitry, a temperature sensor, a pilot, a central maintenance system, a flight management system, and/or the like. In one aspect, the dual redundant configuration of the heater 270 may include dual redundant components for one or more of the various parts of the heater 270. In this aspect, the heater 270 may include one or more dual temperature sensors, dual heating elements, dual power controllers, dual power supplies, dual heating controllers, and/or the like to ensure the ability to be at least partially operative and accordingly certified to fly in icing conditions even if only one channel is operational.

In one aspect, the heater 270 may be a redundant single channel system with a plurality of heaters implemented by a single channel. In this aspect, if one or more of the heaters fail, the remaining heaters may be configured to operate to compensate for the one or more failed heaters. For example, the heater 270 may be configured with adaptive control of a heater duty cycle. In response to a heater failure, the aircraft may be notified that a heater has failed and a maintenance action is needed. However, the heater 270 may be configured such that the aircraft airflow sensor probe 200 may be still at least partially operative and accordingly certified to fly in icing conditions even if one or more of the heaters fail.

With reference to FIG. 2, the aircraft airflow sensor probe 200 may be configured as part of a Line-Replaceable Unit (LRU) 400 that may be connected to the air data computer (ADC) 300. The Line-Replaceable Unit (LRU) 400 configuration of the aircraft airflow sensor probe 200 may be a modular component of the airplane that may be designed to be replaced quickly at an operating location. The Line-Replaceable Unit (LRU) 400 configuration of the aircraft airflow sensor probe 200 may be separate from the air data computer (ADC) 300.

With further reference to FIG. 2, the air data computer (ADC) 300 may be configured as part of a Line-Replaceable Unit (LRU) 400 that may be connected to the aircraft airflow sensor probe 200. The Line-Replaceable Unit (LRU) 400 configuration of the air data computer (ADC) 300 may be a modular component of the airplane that may be designed to be replaced quickly at an operating location. The Line-Replaceable Unit (LRU) 400 configuration of the air data computer (ADC) 300 may be separate from the aircraft airflow sensor probe 200.

With reference to FIG. 3, the aircraft airflow sensor probe 200 and the air data computer (ADC) 300 may be configured as part of a same implementation of a Line-Replaceable Unit (LRU) 400. The Line-Replaceable Unit (LRU) 400 configuration of the aircraft airflow sensor probe 200 and the air data computer (ADC) 300 may be a modular component of the airplane that may be designed to be replaced quickly at an operating location.

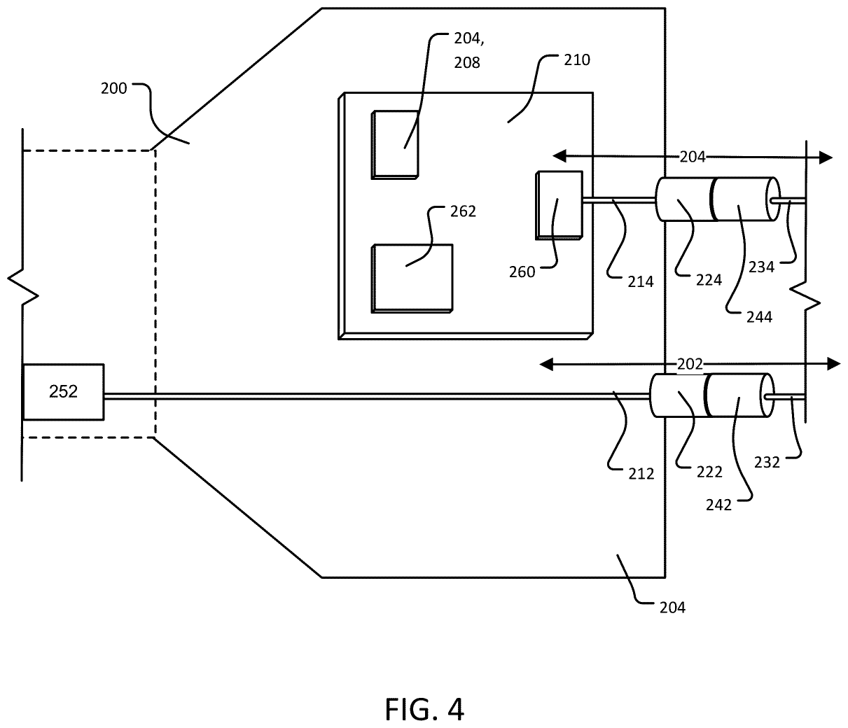

FIG. 4 illustrates a partial internal view of the aircraft airflow sensor probe according to aspects of the disclosure.

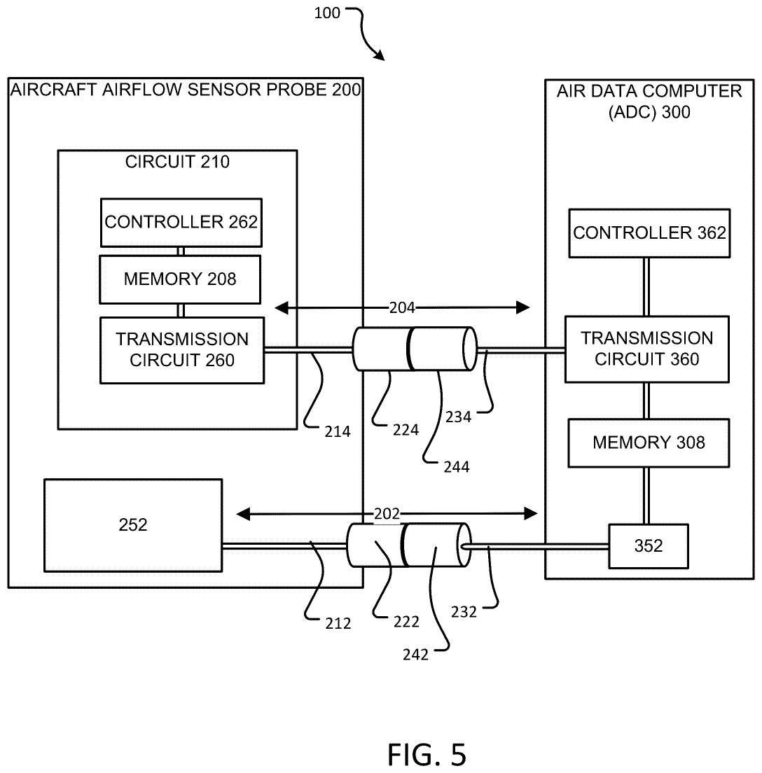

FIG. 5 illustrates a schematic of the aircraft system according to aspects of the disclosure.

As illustrated in FIG. 4 and FIG. 5, the aircraft airflow sensor probe 200 may include a calibration data memory 208, a probe controller 262, a transmission circuit 260, a calibration data circuit 210, and/or the like. In aspects, the probe controller 262 may control operation of the calibration data memory 208, the transmission circuit 260, the calibration data circuit 210, the at least one sensor 252, and/or the like.

In aspects, the calibration data 204 may be stored in the aircraft airflow sensor probe 200 in the calibration data memory 208. In one or more aspects, the calibration data memory 208 may be implemented as a volatile memory, a non-volatile memory (NVM), and/or the like that may be programmed with the calibration data 204. For example, the calibration data memory 208 may be programmed with the calibration data 204 during acceptance testing of the aircraft airflow sensor probe 200 at test facilities and/or the like.

In one or more aspects, the calibration data memory 208 may be implemented as an electronically erasable and programmable read-only memory (EEPROM). In one or more aspects, the calibration data memory 208 may be implemented as a random-access memory (RAM), a read-only memory (ROM), programmable read-only memory (PROM), an erasable programmable read-only memory (EPROM), a dynamic random-access memory (DRAM), a static random-access memory (SRAM), and/or the like.

The calibration data memory 208 may be configured to allow the air data computer (ADC) 300 to download and/or otherwise obtain the calibration data 204 from the aircraft airflow sensor probe 200 upon power up during system initialization, periodically, when the aircraft airflow sensor probe 200 appears to have been newly implemented, and/or the like.

In aspects, implementation of the aircraft airflow sensor probe 200 with the calibration data 204 stored in the calibration data memory 208 may provide a technical solution to simplify maintenance functions in the field since the air data computer (ADC) 300 may not have to be removed and replaced each time an implementation of the aircraft airflow sensor probe 200 is replaced, recalibrated, and/or the like.

In aspects, the calibration data memory 208 may be arranged within the aircraft airflow sensor probe 200 in and/or on a calibration data circuit 210. The calibration data circuit 210 may be configured as a circuit board, a laminated substrate, a printed circuit board (PCB), a printed wire assembly, a printed wiring board (PWB), a surface that mechanically supports and electrically connects the various electronic components or electrical components, and/or the like within the aircraft airflow sensor probe 200. In aspects, the calibration data circuit 210 may be implemented as a laminated sandwich structure of one or more conductive and insulating layers. In aspects, the calibration data circuit 210 may include one or more conductive layers, traces, planes and/or the like.

In aspects, the transmission circuit 260 may be implemented as a communication interface that may include and/or may implement a communication channel, a computer bus, a parallel communication channel, a serial peripheral interface (SPI), one or more communication buses, a Controller Area Network (CAN), and/or the like. In aspects, the transmission circuit 260 may be configured to receive and/or transmit signals including one or more data signals, discrete signals, digital signals, analog signals, and/or the like. In aspects, the transmission circuit 260 may be configured to implement modulation, demodulation, line coding, equalization, error control, bit synchronization, multiplexing, protocol duties, digitizing an analog signal, data compression, data transmission, and/or the like.

The calibration data circuit 210 and/or the transmission circuit 260 may further include components and circuitry that may be extend a transmission distance of the calibration data 204 to the air data computer (ADC) 300 and/or other component of the aircraft system 100. The extended transmission distance may be required to accommodate remote probe installations, such as wing-tip probe installations. In aspects, the calibration data circuit 210 and/or the transmission circuit 260 may be configured to extend a transmission distance of the calibration data 204 in a range of 0.1 m (meters) to 40 m and sub ranges within 0.1 m to 40 m.

The aircraft airflow sensor probe 200 may include at least one probe calibration transmission line 214, at least one probe calibration transmission line connector 224, and/or the like. Further, the aircraft and/or the air data computer (ADC) 300 may have at least one aircraft calibration transmission line 234, at least one aircraft calibration transmission line connector 244, and/or the like.

In aspects, the calibration data 204 may be transmitted via the at least one probe calibration transmission line 214, the at least one probe calibration transmission line connector 224, the at least one aircraft calibration transmission line connector 244, the at least one aircraft calibration transmission line 234, and/or the like to the air data computer (ADC) 300. In aspects, the at least one probe calibration transmission line connector 224 and/or the at least one aircraft calibration transmission line connector 244 may be configured as electrical connectors that may include various electrical mechanical features for connection of the at least one probe calibration transmission line 214 to the at least one aircraft calibration transmission line 234. In aspects, the at least one probe calibration transmission line connector 224 may be electrically connected to the at least one probe calibration transmission line 214, the calibration data circuit 210, the calibration data memory 208, and/or the like to transmit the calibration data 204 between the calibration data memory 208 and the at least one probe calibration transmission line connector 224.

The aircraft airflow sensor probe 200 may include at least one probe data reading transmission line 212, at least one probe data reading transmission line connector 222, and/or the like. Further, the aircraft and/or the air data computer (ADC) 300 may have at least one aircraft data reading transmission line 232, at least one aircraft data reading transmission line connector 242, and/or the like.

In aspects, the data readings 202 may be transmitted from the at least one sensor 252 via the at least one probe data reading transmission line 212, the at least one probe data reading transmission line connector 222, the at least one aircraft data reading transmission line connector 242, the at least one aircraft data reading transmission line 232, and/or the like to the air data computer (ADC) 300. Further, the at least one probe data reading transmission line 212 may be connected to the at least one sensor 252, such as a transducer, a pressure transducer at least one sensor port, and/or the like implemented within the aircraft airflow sensor probe 200.

In aspects, the at least one probe data reading transmission line connector 222 and/or at least one aircraft data reading transmission line connector 242 may be configured as electrical connectors that may include various electrical mechanical features for connection of the at least one probe data reading transmission line 212 to the at least one aircraft data reading transmission line 232. In aspects, the at least one probe data reading transmission line 212 and/or the at least one aircraft data reading transmission line 232 may be implemented electrical transmission lines.

In aspects, the at least one probe data reading transmission line connector 222 and/or the at least one aircraft data reading transmission line connector 242 may be configured as pneumatic connectors that may include various mechanical features for pneumatic connection of the at least one probe data reading transmission line 212 to the at least one aircraft data reading transmission line 232. In aspects, the at least one probe data reading transmission line 212 and/or the at least one aircraft data reading transmission line 232 may be implemented as pneumatic pressure transmission lines.

As illustrated in FIG. 5, the air data computer (ADC) 300 may include a calibration data memory 308, an air data controller 362, a transmission circuit 360, at least one sensor 352, and/or the like. In aspects, the calibration data memory 308 may store the calibration data 204 as the air data sensor information 302. In particular, the calibration data memory 308 may store the calibration data 204 received from the calibration data memory 208 of the aircraft airflow sensor probe 200. Further, the transmission circuit 360 of the air data computer (ADC) 300 may be configured to operate in a similar manner to the transmission circuit 260 of the aircraft airflow sensor probe 200. In aspects, the at least one sensor 352 of the air data computer (ADC) 300 may be at least one pressure transducer. In aspects, the air data computer (ADC) 300 may be implemented without the at least one sensor 352.

In aspects, the air data controller 362 may control the calibration data memory 308, the transmission circuit 360, the at least one sensor 352, and/or the like. Further, the air data controller 362 may be configured to implement a validation process for the aircraft airflow sensor probe 200 and/or the calibration data 204.

In particular, the air data controller 362 may be configured to control loading of the calibration data 204 of the aircraft airflow sensor probe 200 into the calibration data memory 308. Further, the air data controller 362 may be configured to validate the combination of the aircraft airflow sensor probe 200, the calibration data 204, and the air data computer (ADC) 300.

In aspects, the air data controller 362 may generate and send a series of handshakes, validation requests, and/or the like to ensure that the aircraft airflow sensor probe 200 and the calibration data 204 stored by the air data computer (ADC) 300 are properly associated with one another. Once the air data controller 362 receives the appropriate one or more responses from the aircraft airflow sensor probe 200 ensuring that the calibration data 204 currently stored in the air data computer (ADC) 300 is correct, the aircraft system 100 may operate the aircraft airflow sensor probe 200 in conjunction with the air data computer (ADC) 300.

In aspects, the aircraft airflow sensor probe 200, the probe controller 262, and/or the transmission circuit 260 may be configured to send, receive, analyze, and operate based on the calibration data 204. In aspects, the aircraft airflow sensor probe 200, the probe controller 262, and/or the transmission circuit 260 may be configured to send handshake requests, analyze handshake requests, receive handshakes responses, analyze handshake responses, and/or the like. In aspects, the aircraft airflow sensor probe 200, the probe controller 262, and/or the transmission circuit 260 may be configured to send validation requests, analyze validation requests, receive validations responses, analyze validation responses, and/or the like.

In aspects, the air data computer (ADC) 300, the air data controller 362, and/or the transmission circuit 360 may be configured to send, receive, analyze, validate, and operate based on the calibration data 204. In aspects, the air data computer (ADC) 300, the air data controller 362, and/or the transmission circuit 360 may be configured to send handshake requests, analyze handshake requests, receive handshakes responses, analyze handshake responses, and/or the like. In aspects, the air data computer (ADC) 300, the air data controller 362, and/or the transmission circuit 360 may be configured to send validation requests, analyze validation requests, receive validations responses, analyze validation responses, and/or the like.

Accordingly, the aircraft system 100 may be configured to ensure validation of the combination of the aircraft airflow sensor probe 200, the calibration data 204, and the air data computer (ADC) 300. In some aspects, the aircraft system 100 implementing the aircraft airflow sensor probe 200 and the air data computer (ADC) 300 together with the calibration data 204, may include pressure transducers, and/or the like to generate airspeed, Mach number, impact pressure, sideslip information, angle of attack information, an altitude, a measured angle of attack, measured angle of sideslip, an indicated angle of attack, a normalized angle of attack, an actual local flow angle, and/or the like, trends and/or rates for each, and/or the like.

Further, the aircraft airflow sensor probe 200 and the air data computer (ADC) 300 together with the calibration data 204, may be able to provide a more accurate and more repeatable measurement of the airspeed, the Mach number, the impact pressure, the sideslip information, the angle of attack information, the altitude, the measured angle of attack, the measured angle of sideslip, the indicated angle of attack, the normalized angle of attack, the actual local flow angle, and/or the like, trends and/or rates for each, and/or the like.

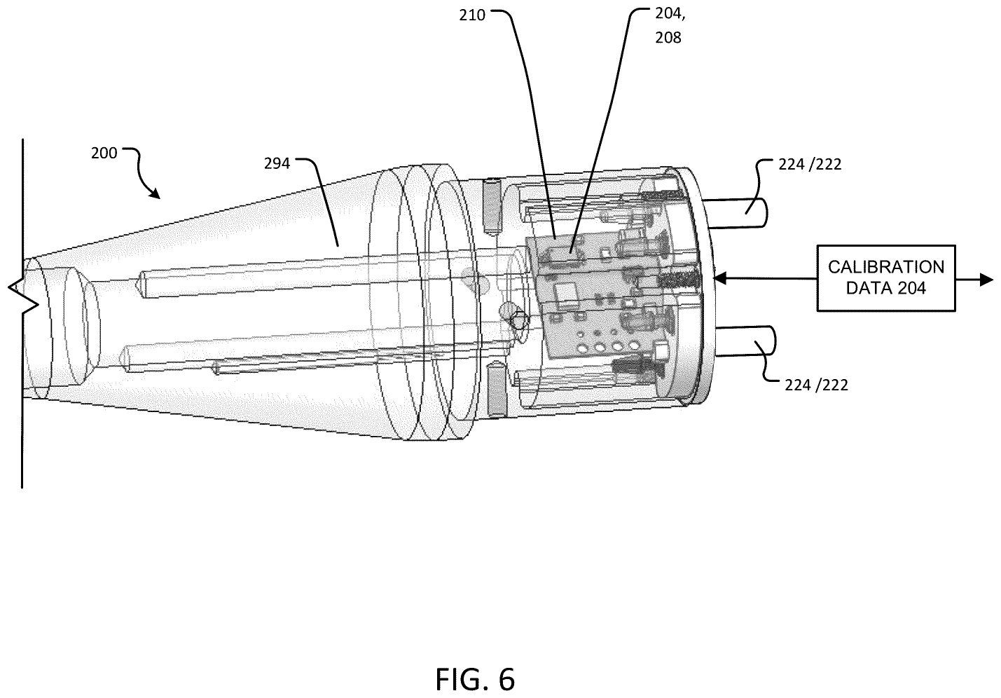

FIG. 6 illustrates partial exemplary internal view of the aircraft airflow sensor probe according to aspects of the disclosure.

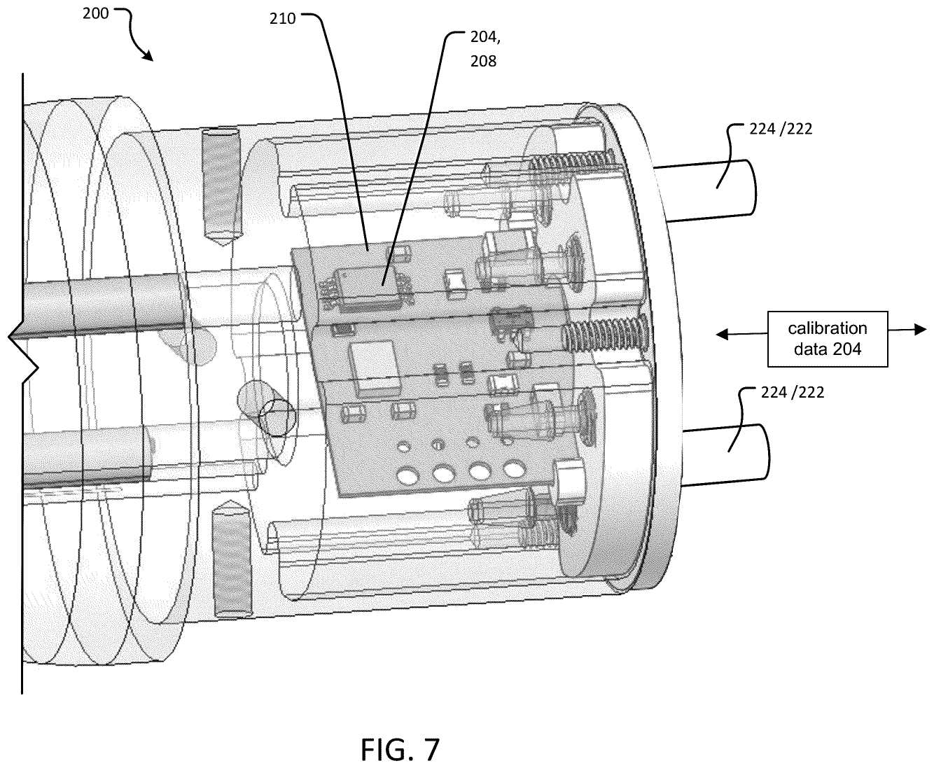

FIG. 7 illustrates another partial exemplary internal view of the aircraft airflow sensor probe according to aspects of the disclosure.

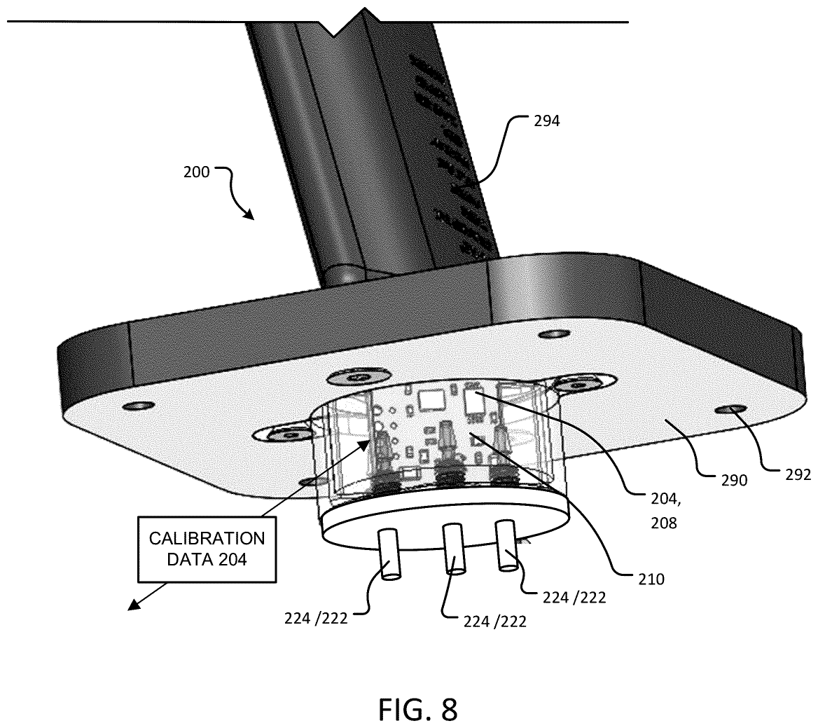

FIG. 8 illustrates another partial exemplary internal view of the aircraft airflow sensor probe according to aspects of the disclosure.

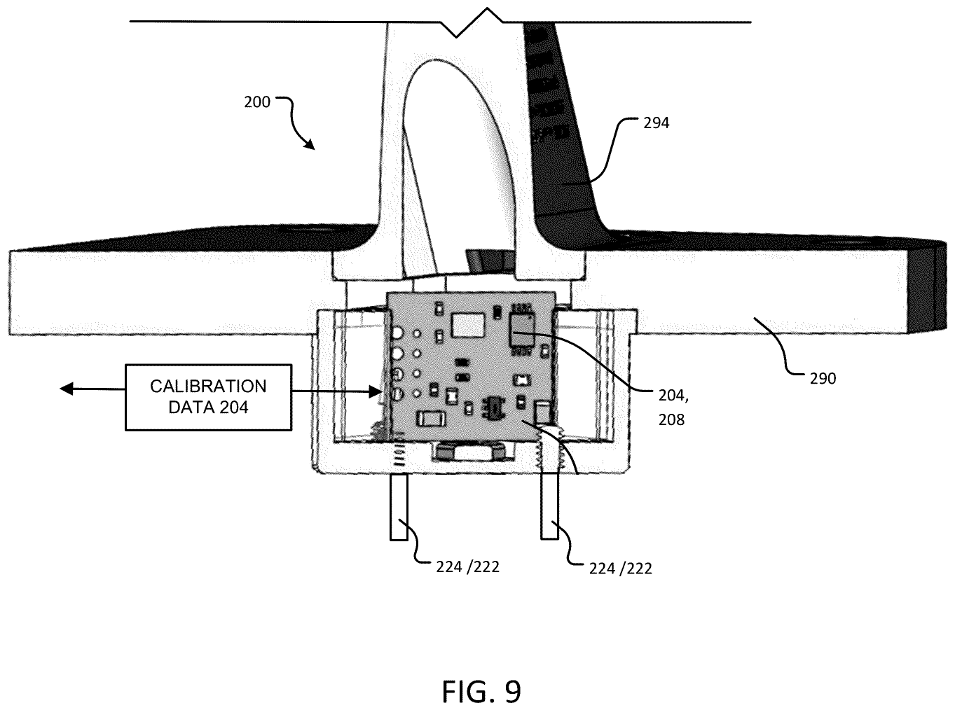

FIG. 9 illustrates another partial exemplary internal view of the aircraft airflow sensor probe according to aspects of the disclosure.

In particular, FIG. 6, FIG. 7, FIG. 8, and FIG. 9 illustrate exemplary implementations of the aircraft airflow sensor probe 200. As illustrated, the aircraft airflow sensor probe 200 may implement an arrangement of the calibration data circuit 210, the calibration data memory 208, the at least one probe data reading transmission line connector 222, and the at least one probe calibration transmission line connector 224 as illustrated. However, the aircraft airflow sensor probe 200 may be implemented in a number of other different ways.

In one aspect as illustrated in FIG. 8 and FIG. 9, the aircraft airflow sensor probe 200 may include a flange 290 on a main housing assembly for attachment to the aircraft and/or the air data computer (ADC) 300. In one aspect, the flange 290 may include flange apertures 292 configured to receive one or more mechanical fasteners for fastening the flange 290 and the aircraft airflow sensor probe 200 to the aircraft.

FIG. 8 and FIG. 9 further illustrate that the aircraft airflow sensor probe 200 may be configured with support structure 294 configured to extend the probe 272 generally perpendicular to an aircraft skin in order to sense a local airstream. The local airstream being generally along the aircraft skin. In one aspect, the aircraft airflow sensor probe 200 may be a forward-fuselage mounted sensor. In one aspect, the aircraft airflow sensor probe 200 may be electrically anti-iced by the heater 270.

In one aspect, the support structure 294 may include structure for connecting the probe 272 to portions of the aircraft airflow sensor probe 200 internal to the aircraft such as a main housing assembly arranged internally within the aircraft. In one aspect, the flange 290 and the flange apertures 292 may be configured for fastening the flange 290 and the aircraft airflow sensor probe 200 to the Line-Replaceable Unit (LRU) 400, the air data computer (ADC) 300, a Line-Replaceable Unit (LRU) 400 implementing the air data computer (ADC) 300, and/or the like.

In one aspect, the aircraft airflow sensor probe 200, the air data computer (ADC) 300, and/or the Line-Replaceable Unit (LRU) 400 may include signal connections. In one aspect, the signal connections may be connected to (as defined herein) the aircraft to provide sensor readings and the like to the aircraft. In one aspect, the signal connections may be electrical connections. In one aspect, the signal connections may be optical connections. In one aspect, the signal connections may be electrical and/or optical connections. In one aspect, the signal connections may also receive sensor readings and/or commands for operating the aircraft airflow sensor probe 200, the air data computer (ADC) 300, and/or the Line-Replaceable Unit (LRU) 400 from the aircraft and/or the aircraft system 100. In one aspect, the signal connections may also receive power for operating the aircraft airflow sensor probe 200, the air data computer (ADC) 300, and/or the Line-Replaceable Unit (LRU) 400.

In one aspect, the aircraft airflow sensor probe 200, the air data computer (ADC) 300, and/or the Line-Replaceable Unit (LRU) 400 may include a processor, or other processor that may utilize the data readings 202, the calibration data 204, and/or like and may calculate the desired output parameters. In one aspect, the processor may include sensor circuitry that may include an analog to digital converter, a filter, other signal conditioning circuitry, and/or the like to determine angle of attack (AOA), rate of change of the angle of attack (AOA), calculate airspeed, Mach number, an altitude, an altitude trend, and/or the like.

The aircraft airflow sensor probe 200, the air data computer (ADC) 300, and/or the Line-Replaceable Unit (LRU) 400 may include hardware that may be responsible for all environmental protection, any power conditioning, and conversion, raw signal sensing, relay of signal data, and/or the like. The aircraft airflow sensor probe 200, the air data computer (ADC) 300, and/or the Line-Replaceable Unit (LRU) 400 may include software implemented by a processor that may be responsible for the calibration data 204, the data readings 202, data monitoring, data conversion, calculations, operational modes, coordinating/configuring hardware to sense, send, or receive data, and/or the like.

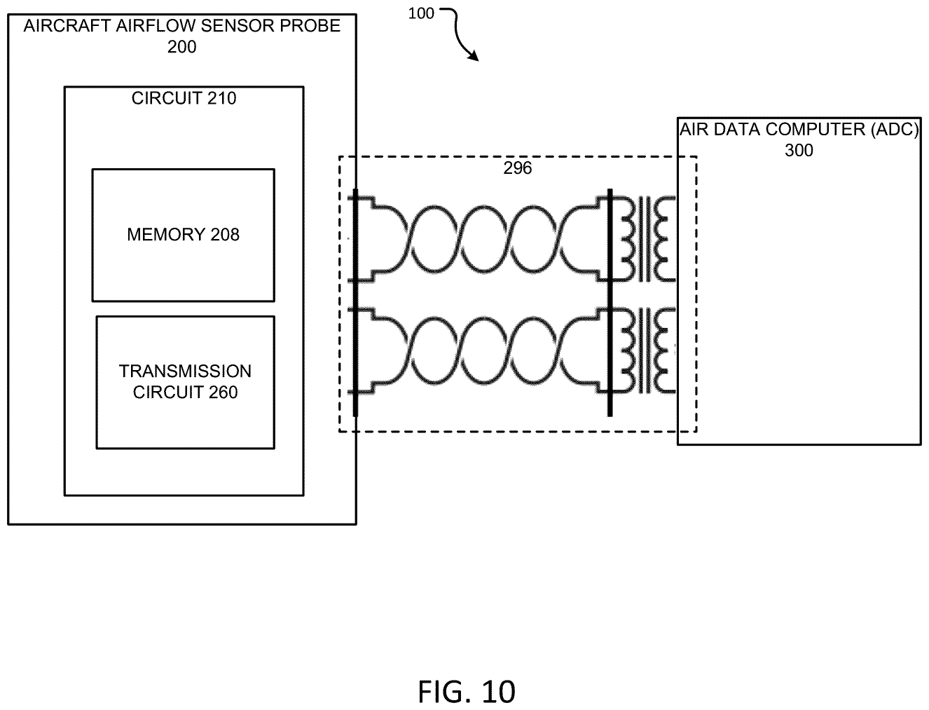

FIG. 10 illustrates a schematic of the aircraft system including the aircraft airflow sensor probe and the air data computer (ADC) according to aspects of the disclosure.

In particular, FIG. 10 illustrates a schematic of the aircraft system 100 including the aircraft airflow sensor probe 200 and the air data computer (ADC) 300 that may include implementation of isolation circuitry 296. In aspects, the isolation circuitry 296 may provide lightning isolation between the aircraft airflow sensor probe 200 and the air data computer (ADC) 300. In aspects, the isolation circuitry 296 may provide lightning compliance, meet lightning requirements, and/or the like.

In aspects, the isolation circuitry 296 may be implemented as an isolation transformer circuit to protect against electric shock, suppress electrical noise, transfer power, and/or the like between the aircraft airflow sensor probe 200 and the air data computer (ADC) 300. In other aspects of the aircraft system 100 there may not be any implementation of the isolation circuitry 296.

In one aspect, the one or more pressure transducers may be configured to measure a total pressure, a stagnation pressure, a pitot pressure, and/or the like. In some aspects, the output of the one or more pressure transducer may be processed in a processor in the aircraft system 100, the aircraft airflow sensor probe 200, and/or the air data computer (ADC) 300 to generate the angle of attack (AOA), the angle of sideslip (AOS), an airspeed, a Mach number, and/or the like aircraft information.

In one aspect, the aircraft airflow sensor probe 200 and the probe 272 may be configured as, in part, an angle of attack sensor to provide normalized angle of attack (AOA) information for flight control systems, a navigation system, a flight management system, a pilot, and/or the like. In one aspect, the aircraft airflow sensor probe 200 may be configured as a Stall Warning Transmitter (SWT) to provide stall protection functionality for flight control systems.

In one aspect, the aircraft airflow sensor probe 200 may include signal connections on the main housing assembly and/or the rear cover. In one aspect, the signal connections may be connected to the aircraft to provide sensor readings and the like to the aircraft. In one aspect, the signal connections may be electrical connections. In one aspect, the signal connections may be optical connections. In one aspect, the signal connections may be electrical and/or optical connections. In one aspect, the signal connections may also receive sensor readings and/or commands for operating the aircraft airflow sensor probe 200 from the aircraft. In one aspect, the signal connections may also receive power for operating the aircraft airflow sensor probe 200 from the aircraft.

In aspects, the aircraft airflow sensor probe 200 and/or the air data computer (ADC) 300 may include hardware that may be responsible for all environmental protection, any power conditioning, and conversion, raw signal sensing, relay of signal data, and/or the like. The aircraft airflow sensor probe 200 and/or the air data computer (ADC) 300 may include software implemented by a processor such as the processor that may be responsible for data monitoring, data conversion, calculations, operational modes, coordinating/configuring hardware to sense, send, or receive data, and/or the like.

The aircraft airflow sensor probe 200 and/or the air data computer (ADC) 300 may include a power supply module. The power supply module may provide conditioned power to a stall warning computer, angular position transmitter electronics, the pressure transducer, the measurement circuitry, the processor, and/or other components. In some aspects, the power supply module may be configured on a printed circuit board, on a printed wire assembly, and/or the like within the aircraft airflow sensor probe 200 and/or the air data computer (ADC) 300.

The aircraft airflow sensor probe 200 may include an input/output (I/O) module. The input/output (I/O) module may relay signals and may connect to power buses between external aircraft systems, Stall Warning Transmitter (SWT) hardware, and/or the like. The input/output (I/O) module may also provide the circuitry to meet lightning, Electromagnetic Interference (EMI), high-intensity radiated field (HIRF) requirements, and/or the like.

The aircraft airflow sensor probe 200 can be mechanically mounted on either the port side, the starboard side, or both sides of the forward fuselage and may electrically connect to several aircraft discretes, power, dual redundant ARINC communication busses, and the like through signal connections. However, it should be noted that any type of data bus may be utilized including ARINC, MIL-STD-1553 (military standard), Controller Area Network (CAN), and the like. The aircraft airflow sensor probe 200 may also provide a maintenance interface, not connected to the aircraft, allowing for configurations, alignment adjustments, software uploads, and/or the like.

In one aspect, the aircraft airflow sensor probe 200 and/or the air data computer (ADC) 300 may be implemented in part as a Stall Warning Transmitter (SWT) and may provide stall warning and protection by utilizing the aircraft airflow sensor probe 200. The Stall Warning Transmitter (SWT) may calculate a normalized AOA (AOAN), presented as a fraction of the angle of attack interval from zero lift to stall, for a particular configuration of the host aircraft. A distinct aircraft configuration may be determined by the combined state of the flaps, speed brake, anti-ice, and/or the like input parameters to the Stall Warning Transmitter (SWT). From the AOAN, host configuration, and detailed lift curves, and/or the like, the Stall Warning Transmitter (SWT) may calculate and enact various stall warning limits such as: Horn, Stick Shake, and Stick Push.

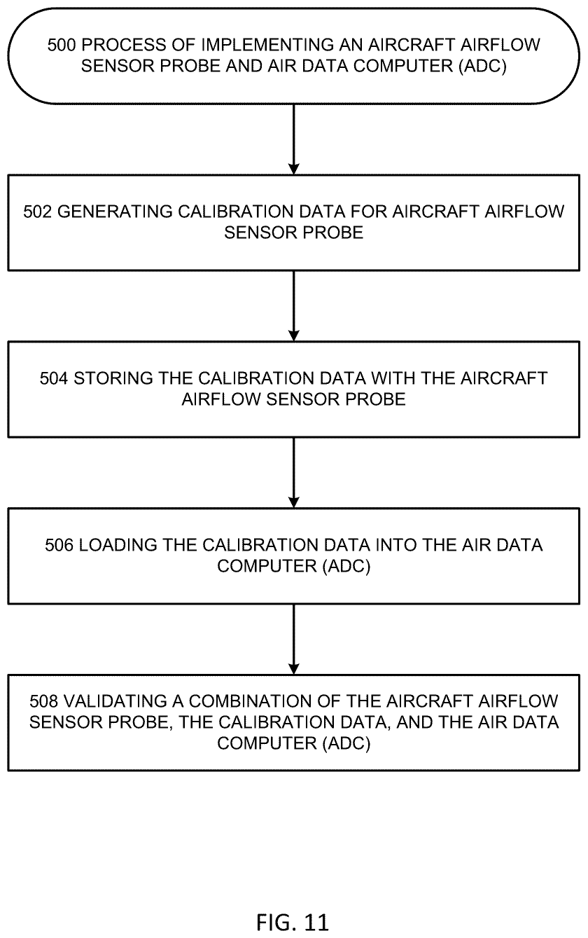

FIG. 11 illustrates a process of implementing an aircraft airflow sensor probe and air data computer (ADC) according to the disclosure.

In particular, FIG. 11 illustrates a process of implementing an aircraft airflow sensor probe and air data computer (ADC) 500. In particular, it should be noted that the process of implementing an aircraft airflow sensor probe and air data computer (ADC) 500 is merely exemplary and may be modified consistent with the various aspects disclosed herein. Moreover, the process of implementing an aircraft airflow sensor probe and air data computer (ADC) 500 of the disclosure may include a process of manufacturing the aircraft airflow sensor probe 200 and/or the air data computer (ADC) 300. It should be noted that the process of implementing an aircraft airflow sensor probe and air data computer (ADC) 500 may be performed in a different order consistent with the aspects described above. Moreover, the process of implementing an aircraft airflow sensor probe and air data computer (ADC) 500 may be modified to have more or fewer process steps consistent with the various aspects disclosed herein.

In aspects, the process of implementing an aircraft airflow sensor probe and air data computer (ADC) 500 may be implemented in software executed on one or more processors of the aircraft airflow sensor probe 200, one or more processors of the air data computer (ADC) 300, the probe controller 262, the air data controller 362, and/or the like. In aspects, the process of implementing an aircraft airflow sensor probe and air data computer (ADC) 500 may include storing calibration data within an aircraft airflow data probe and the ability for a remotely connected Air Data Computer (ADC) to automatically validate that the correct calibration data is loaded into the ADC without human intervention.

In particular, the process of implementing an aircraft airflow sensor probe and air data computer (ADC) 500 may include storing the calibration data 204 within the aircraft airflow sensor probe 200. Further, the process of implementing an aircraft airflow sensor probe and air data computer (ADC) 500 may include implementing the aircraft airflow sensor probe 200 with the ability for a connected and/or remotely connected implementation of the air data computer (ADC) 300 to automatically validate that the correct calibration data is loaded into the air data computer (ADC) 300 without human intervention.

In aspects, the process of implementing an aircraft airflow sensor probe and air data computer (ADC) 500 may include generating calibration data for aircraft airflow sensor probe 502. In particular, the generating calibration data for aircraft airflow sensor probe 502 may include generating calibration data 204 for aircraft airflow sensor probe 200 as described herein. In this regard, the calibration data 204 may be specific to a particular implementation of the aircraft airflow sensor probe 200 and/or the aircraft. More specifically, implementations of the aircraft airflow sensor probe 200 may be tested in testing facilities to ascertain and/or obtain a specific collection of the calibration data 204 for a particular implementation of the aircraft airflow sensor probe 200.

In aspects, the process of implementing an aircraft airflow sensor probe and air data computer (ADC) 500 may include storing the calibration data with the aircraft airflow sensor probe 504. In particular, the storing the calibration data with the aircraft airflow sensor probe 504 may include storing the calibration data 204 with the aircraft airflow sensor probe 200 as described herein. For example, the calibration data 204 may be stored in the aircraft airflow sensor probe 200 in the calibration data memory 208.

In aspects, the process of implementing an aircraft airflow sensor probe and air data computer (ADC) 500 may include loading the calibration data into the air data computer (ADC) 506. In particular, the loading the calibration data into the air data computer (ADC) 506 may include loading the calibration data 204 into the air data computer (ADC) 300 as described herein. For example, the calibration data 204 of the aircraft airflow sensor probe 200 may be downloaded, transmitted, and/or provided to the air data computer (ADC) 300 and/or the aircraft system 100 to which the aircraft airflow sensor probe 200 is attached.

In aspects, the process of implementing an aircraft airflow sensor probe and air data computer (ADC) 500 may include validating a combination of the aircraft airflow sensor probe, the calibration data, and the air data computer (ADC) 508. In particular, the validating a combination of the aircraft airflow sensor probe, the calibration data, and the air data computer (ADC) 508 may include validating the combination of the aircraft airflow sensor probe 200, the calibration data 204, and the air data computer (ADC) 300 as described herein. Further, during initiation of the aircraft system 100, the air data computer (ADC) 300 may generate and send a series of handshakes, validation requests, and/or the like to ensure that the aircraft airflow sensor probe 200 and the calibration data 204 stored by the air data computer (ADC) 300 are properly associated with one another. Once the air data computer (ADC) 300 receives the appropriate one or more responses from the aircraft airflow sensor probe 200 ensuring that the calibration data 204 currently stored in the air data computer (ADC) 300 is correct, the aircraft system 100 may operate the aircraft airflow sensor probe 200 in conjunction with the air data computer (ADC) 300.

Accordingly, the disclosure has set forth an aircraft airflow data probe, Air Data System, and/or Air Data Computer configured to reduce a likelihood of calibration data mismatch. Further, the disclosure as set forth a process of implementing an aircraft airflow data probe, Air Data System, and/or Air Data Computer configured to reduce a likelihood of calibration data mismatch.

The following are a number of nonlimiting EXAMPLES of aspects of the disclosure.

One EXAMPLE: an aircraft airflow sensor includes one or more pitot inlets, ports, and/or static ports. The aircraft airflow sensor in addition includes a calibration data memory physically storing calibration data with the aircraft airflow sensor probe. The aircraft airflow sensor moreover includes where the calibration data is configured to be implemented in an air data computer (ADC).

The above-noted EXAMPLE may further include any one or a combination of more than one of the following EXAMPLES: The aircraft airflow sensor of the above-noted EXAMPLE includes a structure, a housing, and/or components, where the calibration data is on, attached to, or within the structure, the housing, and/or the components of the aircraft airflow sensor probe. The aircraft airflow sensor of the above-noted EXAMPLE where the calibration data is configured to be integrated into the aircraft airflow sensor probe. The aircraft airflow sensor of the above-noted EXAMPLE where the calibration data is data configured to correlate certain collected air pressures and/or electrical signals generated from air pressures in and/or by the aircraft airflow sensor probe to provide calibration adjustments to increase accuracy and/or repeatability for sensor readings from the aircraft airflow sensor probe. The aircraft airflow sensor of the above-noted EXAMPLE where the calibration data of the aircraft airflow sensor probe is configured to be specific to a specific implementation of the aircraft airflow sensor probe. The aircraft airflow sensor of the above-noted EXAMPLE where the calibration data of the aircraft airflow sensor probe is configured to be specific to a specific implementation of an aircraft that utilizes the aircraft airflow sensor probe. The aircraft airflow sensor of the above-noted EXAMPLE where the calibration data of the aircraft airflow sensor probe is configured to be specific to a specific implementation of the aircraft airflow sensor probe; and where the calibration data of the aircraft airflow sensor probe is further configured to be specific to a specific implementation of an aircraft that utilizes the aircraft airflow sensor probe. The aircraft airflow sensor of the above-noted EXAMPLE where the calibration data is a series of calibration values arranged in a lookup table providing calibration amounts and/or offset amounts. The aircraft airflow sensor of the above-noted EXAMPLE where the calibration data is a series of constants and/or variables providing calibration amounts and/or offset amounts for the aircraft airflow sensor probe and/or an aircraft. The aircraft airflow sensor of the above-noted EXAMPLE where the calibration data is one or more polynomial functions for providing calibration amounts and/or offset amounts for the aircraft airflow sensor probe and/or an aircraft. The aircraft airflow sensor of the above-noted EXAMPLE where the calibration data comprises a serial number identifying a specific calibration data associated with an implementation of the aircraft airflow sensor probe. The aircraft airflow sensor of the above-noted EXAMPLE where the calibration data and/or the aircraft airflow sensor probe comprises integrity checking mechanisms. The aircraft airflow sensor of the above-noted EXAMPLE where the aircraft airflow sensor probe is configured as part of a Line-Replaceable Unit (LRU) that is connected to the air data computer (ADC). The aircraft airflow sensor probe of the above-noted EXAMPLE includes a probe controller, a transmission circuit, and a calibration data circuit, where the probe controller is configured to control and operation of the calibration data memory, the transmission circuit, and/or the calibration data circuit. The aircraft airflow sensor probe of the above-noted EXAMPLE where the transmission circuit is implemented as a communication interface that comprises and/or implements a serial peripheral interface (SPI). The aircraft airflow sensor probe of the above-noted EXAMPLE where the transmission circuit is implemented as a communication interface that comprises and/or implements a communication channel. The aircraft airflow sensor probe of the above-noted EXAMPLE where the transmission circuit comprises components and circuitry that extends a transmission distance of the calibration data to the air data computer (ADC). The aircraft airflow sensor probe of the above-noted EXAMPLE includes at least one probe calibration transmission line, where the calibration data is transmitted via the at least one probe calibration transmission line. The aircraft airflow sensor probe of the above-noted EXAMPLE includes at least one probe data reading transmission line implemented as an electrical transmission line. The aircraft airflow sensor probe of the above-noted EXAMPLE includes at least one probe data reading transmission line implemented as pneumatic pressure transmission line. The aircraft airflow sensor probe of the above-noted EXAMPLE where the calibration data memory is implemented as a volatile memory. The aircraft airflow sensor probe of the above-noted EXAMPLE where the calibration data memory is implemented as a non-volatile memory (NVM). The aircraft airflow sensor probe of the above-noted EXAMPLE where the calibration data memory is implemented as an electronically erasable and programmable read-only memory (EEPROM). The aircraft airflow sensor probe of the above-noted EXAMPLE where the calibration data memory is configured to allow the air data computer (ADC) to download and/or otherwise obtain the calibration data from the aircraft airflow sensor probe. The aircraft airflow sensor probe of the above-noted EXAMPLE where the calibration data memory is arranged within the aircraft airflow sensor probe in and/or on a calibration data circuit. The aircraft system of the above-noted EXAMPLE and includes the air data computer (ADC). The aircraft system of the above-noted EXAMPLE where the air data computer (ADC) is configured to utilize the calibration data in conjunction with data readings in order to provide air data sensor information having greater accuracy and/or repeatability. The aircraft system of the above-noted EXAMPLE where the air data computer (ADC) comprises a calibration data memory, an air data controller, and a transmission circuit. The aircraft system of the above-noted EXAMPLE where the air data controller is configured to implement a validation process for the aircraft airflow sensor probe and/or the calibration data. The aircraft system of the above-noted EXAMPLE where the air data controller is configured to control loading of the calibration data of the aircraft airflow sensor probe. The aircraft system of the above-noted EXAMPLE where the air data controller is configured to generate and send a series of handshakes and/or validation requests to ensure that the aircraft airflow sensor probe and the calibration data stored by the air data computer (ADC) are properly associated with one another. The aircraft system of the above-noted EXAMPLE where the aircraft system is implemented as an Air Data System (ADS) and/or a federated Air Data Systems (ADS).

One EXAMPLE: a process includes providing one or more pitot inlets, ports, and/or static ports. The process in addition includes physically storing calibration data with the aircraft airflow sensor probe in a calibration data memory. The process moreover includes where the calibration data is configured to be implemented in an air data computer (ADC).

The above-noted EXAMPLE may further include any one or a combination of more than one of the following EXAMPLES: The process of the above-noted EXAMPLE includes: providing a structure, a housing, and/or components; and arranging the calibration data on or within the structure, the housing, and/or the components of the aircraft airflow sensor probe. The process of the above-noted EXAMPLE where the calibration data is configured to be integrated into the aircraft airflow sensor probe. The process of the above-noted EXAMPLE where the calibration data is data configured to correlate certain collected air pressures and/or electrical signals generated from air pressures in and/or by the aircraft airflow sensor probe to provide calibration adjustments to increase accuracy and/or repeatability for sensor readings from the aircraft airflow sensor probe. The process of the above-noted EXAMPLE where the calibration data of the aircraft airflow sensor probe is configured to be specific to a specific implementation of the aircraft airflow sensor probe. The process of the above-noted EXAMPLE where the calibration data of the aircraft airflow sensor probe is configured to be specific to a specific implementation of an aircraft that utilizes the aircraft airflow sensor probe. The process of the above-noted EXAMPLE where the calibration data of the aircraft airflow sensor probe is configured to be specific to a specific implementation of the aircraft airflow sensor probe; and where the calibration data of the aircraft airflow sensor probe is further configured to be specific to a specific implementation of an aircraft that utilizes the aircraft airflow sensor probe. The process of the above-noted EXAMPLE where the calibration data is a series of calibration values arranged in a lookup table providing calibration amounts and/or offset amounts. The process of the above-noted EXAMPLE where the calibration data is a series of constants and/or variables providing calibration amounts and/or offset amounts for the aircraft airflow sensor probe and/or an aircraft. The process of the above-noted EXAMPLE where the calibration data is one or more polynomial functions for providing calibration amounts and/or offset amounts for the aircraft airflow sensor probe and/or an aircraft. The process of the above-noted EXAMPLE where the calibration data comprises a serial number identifying a specific calibration data associated with an implementation of the aircraft airflow sensor probe. The process of the above-noted EXAMPLE where the calibration data and/or the aircraft airflow sensor probe comprises integrity checking mechanisms. The process of the above-noted EXAMPLE where the aircraft airflow sensor probe is configured as part of a Line-Replaceable Unit (LRU) that is connected to the air data computer (ADC). The process of the above-noted EXAMPLE includes providing a probe controller, a transmission circuit, and a calibration data circuit, where the probe controller is configured to control and operation of the calibration data memory, the transmission circuit, and/or the calibration data circuit. The process of the above-noted EXAMPLE where the transmission circuit is implemented as a communication interface that comprises and/or implements a serial peripheral interface (SPI). The process of the above-noted EXAMPLE where the transmission circuit is implemented as a communication interface that comprises and/or implements a communication channel. The process of the above-noted EXAMPLE where the transmission circuit comprises components and circuitry that extends a transmission distance of the calibration data to the air data computer (ADC). The process of the above-noted EXAMPLE includes providing at least one probe calibration transmission line, where the calibration data is transmitted via the at least one probe calibration transmission line. The process of the above-noted EXAMPLE includes providing at least one probe data reading transmission line implemented as an electrical transmission line. The process of the above-noted EXAMPLE includes providing at least one probe data reading transmission line implemented as pneumatic pressure transmission line. The process of the above-noted EXAMPLE where the calibration data memory is implemented as a volatile memory. The process of the above-noted EXAMPLE where the calibration data memory is implemented as a non-volatile memory (NVM). The process of the above-noted EXAMPLE where the calibration data memory is implemented as an electronically erasable and programmable read-only memory (EEPROM). The process of the above-noted EXAMPLE where the calibration data memory is configured to allow the air data computer (ADC) to download and/or otherwise obtain the calibration data from the aircraft airflow sensor probe. The process of the above-noted EXAMPLE where the calibration data memory is arranged within the aircraft airflow sensor probe in and/or on a calibration data circuit.

Further in accordance with various aspects of the disclosure, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the disclosure as described herein are optionally stored on a tangible non-transitory storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the disclosure is considered to include a tangible storage medium or distribution medium, as listed herein and including art-recognized equivalents and successor media, in which the software implementations herein are stored.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

The many features and advantages of the disclosure are apparent from the detailed specification, and, thus, it is intended by the appended claims to cover all such features and advantages of the disclosure, which fall within the true spirit, and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. An aircraft airflow sensor probe comprising:
one or more pitot inlets, ports, and/or static ports; and
a calibration data memory physically storing calibration data with the aircraft airflow sensor probe,
wherein the calibration data is configured to be implemented in an air data computer (ADC).

2. The aircraft airflow sensor probe according to claim 1, further comprising a structure, a housing, and/or components, wherein the calibration data is on, attached to, or within the structure, the housing, and/or the components of the aircraft airflow sensor probe.

3. The aircraft airflow sensor probe according to claim 1, wherein the calibration data is configured to be integrated into the aircraft airflow sensor probe.

4. The aircraft airflow sensor probe according to claim 1, wherein the calibration data is data configured to correlate certain collected air pressures and/or electrical signals generated from air pressures in and/or by the aircraft airflow sensor probe to provide calibration adjustments to increase accuracy and/or repeatability for sensor readings from the aircraft airflow sensor probe.

5. The aircraft airflow sensor probe according to claim 1, wherein the calibration data of the aircraft airflow sensor probe is configured to be specific to a specific implementation of the aircraft airflow sensor probe.

6. The aircraft airflow sensor probe according to claim 1, wherein the calibration data of the aircraft airflow sensor probe is configured to be specific to a specific implementation of an aircraft that utilizes the aircraft airflow sensor probe.

7. The aircraft airflow sensor probe according to claim 1,
wherein the calibration data of the aircraft airflow sensor probe is configured to be specific to a specific implementation of the aircraft airflow sensor probe; and
wherein the calibration data of the aircraft airflow sensor probe is further configured to be specific to a specific implementation of an aircraft that utilizes the aircraft airflow sensor probe.

8. The aircraft airflow sensor probe according to claim 1, wherein the calibration data is a series of calibration values arranged in a lookup table providing calibration amounts and/or offset amounts.

9. The aircraft airflow sensor probe according to claim 1, wherein the calibration data is a series of constants and/or variables providing calibration amounts and/or offset amounts for the aircraft airflow sensor probe and/or an aircraft.

10. The aircraft airflow sensor probe according to claim 1, wherein the calibration data is one or more polynomial functions for providing calibration amounts and/or offset amounts for the aircraft airflow sensor probe and/or an aircraft.

11. The aircraft airflow sensor probe according to claim 1, wherein the calibration data comprises a serial number identifying a specific calibration data associated with an implementation of the aircraft airflow sensor probe.

12. The aircraft airflow sensor probe according to claim 1, wherein the calibration data and/or the aircraft airflow sensor probe comprises integrity checking mechanisms.

13. The aircraft airflow sensor probe according to claim 1, wherein the aircraft airflow sensor probe is configured as part of a Line-Replaceable Unit (LRU) that is connected to the air data computer (ADC).

14. The aircraft airflow sensor probe according to claim 1, further comprising a probe controller, a transmission circuit, and a calibration data circuit,
wherein the probe controller is configured to control and operation of the calibration data memory, the transmission circuit, and/or the calibration data circuit.

15. The aircraft airflow sensor probe according to claim 14, wherein the transmission circuit is implemented as a communication interface that comprises and/or implements a serial peripheral interface (SPI).

16. The aircraft airflow sensor probe according to claim 14, wherein the transmission circuit is implemented as a communication interface that comprises and/or implements a communication channel.

17. The aircraft airflow sensor probe according to claim 14, wherein the transmission circuit comprises components and circuitry that extends a transmission distance of the calibration data to the air data computer (ADC).

18. The aircraft airflow sensor probe according to claim 1, further comprising at least one probe calibration transmission line, wherein the calibration data is transmitted via the at least one probe calibration transmission line.

19. The aircraft airflow sensor probe according to claim 18, further comprising at least one probe data reading transmission line implemented as an electrical transmission line.

20. The aircraft airflow sensor probe according to claim 18, further comprising at least one probe data reading transmission line implemented as pneumatic pressure transmission line.

21. The aircraft airflow sensor probe according to claim 1, wherein the calibration data memory is implemented as a volatile memory.

22. The aircraft airflow sensor probe according to claim 1, wherein the calibration data memory is implemented as a non-volatile memory (NVM).

23. The aircraft airflow sensor probe according to claim 1, wherein the calibration data memory is implemented as an electronically erasable and programmable read-only memory (EEPROM).

24. The aircraft airflow sensor probe according to claim 1, wherein the calibration data memory is configured to allow the air data computer (ADC) to download and/or otherwise obtain the calibration data from the aircraft airflow sensor probe.

25. The aircraft airflow sensor probe according to claim 1, wherein the calibration data memory is arranged within the aircraft airflow sensor probe in and/or on a calibration data circuit.

26. An aircraft system comprising the aircraft airflow sensor probe according to claim 1 and further comprising the air data computer (ADC).

27. The aircraft system according to claim 26, wherein the air data computer (ADC) is configured to utilize the calibration data in conjunction with data readings in order to provide air data sensor information having greater accuracy and/or repeatability.

28. The aircraft system according to claim 26, wherein the air data computer (ADC) comprises a calibration data memory, an air data controller, and a transmission circuit.

29. The aircraft system according to claim 28, wherein the air data controller is configured to implement a validation process for the aircraft airflow sensor probe and/or the calibration data.

30. The aircraft system according to claim 28, wherein the air data controller is configured to control loading of the calibration data of the aircraft airflow sensor probe.

31. The aircraft system according to claim 28, wherein the air data controller is configured to generate and send a series of handshakes and/or validation requests to ensure that the aircraft airflow sensor probe and the calibration data stored by the air data computer (ADC) are properly associated with one another.

32. The aircraft system according to claim 26, wherein the aircraft system is implemented as an Air Data System (ADS) and/or a federated Air Data Systems (ADS).

33. A process of implementing and aircraft airflow sensor probe comprising:
providing one or more pitot inlets, ports, and/or static ports; and
physically storing calibration data with the aircraft airflow sensor probe in a calibration data memory,
wherein the calibration data is configured to be implemented in an air data computer (ADC).

34. The process of implementing and aircraft airflow sensor probe according to claim 33, further comprising:
providing a structure, a housing, and/or components; and
arranging the calibration data on or within the structure, the housing, and/or the components of the aircraft airflow sensor probe.

35. The process of implementing and aircraft airflow sensor probe according to claim 33, wherein the calibration data is configured to be integrated into the aircraft airflow sensor probe.

36. The process of implementing and aircraft airflow sensor probe according to claim 33, wherein the calibration data is data configured to correlate certain collected air pressures and/or electrical signals generated from air pressures in and/or by the aircraft airflow sensor probe to provide calibration adjustments to increase accuracy and/or repeatability for sensor readings from the aircraft airflow sensor probe.

37. The process of implementing and aircraft airflow sensor probe according to claim 33, wherein the calibration data of the aircraft airflow sensor probe is configured to be specific to a specific implementation of the aircraft airflow sensor probe.

38. The process of implementing and aircraft airflow sensor probe according to claim 33, wherein the calibration data of the aircraft airflow sensor probe is configured to be specific to a specific implementation of an aircraft that utilizes the aircraft airflow sensor probe.

39. The process of implementing and aircraft airflow sensor probe according to claim 33,
wherein the calibration data of the aircraft airflow sensor probe is configured to be specific to a specific implementation of the aircraft airflow sensor probe; and
wherein the calibration data of the aircraft airflow sensor probe is further configured to be specific to a specific implementation of an aircraft that utilizes the aircraft airflow sensor probe.

40. The process of implementing and aircraft airflow sensor probe according to claim 33, wherein the calibration data is a series of calibration values arranged in a lookup table providing calibration amounts and/or offset amounts.

41. The process of implementing and aircraft airflow sensor probe according to claim 33, wherein the calibration data is a series of constants and/or variables providing calibration amounts and/or offset amounts for the aircraft airflow sensor probe and/or an aircraft.

42. The process of implementing and aircraft airflow sensor probe according to claim 33, wherein the calibration data is one or more polynomial functions for providing calibration amounts and/or offset amounts for the aircraft airflow sensor probe and/or an aircraft.

43. The process of implementing and aircraft airflow sensor probe according to claim 33, wherein the calibration data comprises a serial number identifying a specific calibration data associated with an implementation of the aircraft airflow sensor probe.

44. The process of implementing and aircraft airflow sensor probe according to claim 33, wherein the calibration data and/or the aircraft airflow sensor probe comprises integrity checking mechanisms.

45. The process of implementing and aircraft airflow sensor probe according to claim 33, wherein the aircraft airflow sensor probe is configured as part of a Line-Replaceable Unit (LRU) that is connected to the air data computer (ADC).

46. The process of implementing and aircraft airflow sensor probe according to claim 33, further comprising providing a probe controller, a transmission circuit, and a calibration data circuit,
wherein the probe controller is configured to control and operation of the calibration data memory, the transmission circuit, and/or the calibration data circuit.

47. The process of implementing and aircraft airflow sensor probe according to claim 46, wherein the transmission circuit is implemented as a communication interface that comprises and/or implements a serial peripheral interface (SPI).

48. The process of implementing and aircraft airflow sensor probe according to claim 46, wherein the transmission circuit is implemented as a communication interface that comprises and/or implements a communication channel.

49. The process of implementing and aircraft airflow sensor probe according to claim 46, wherein the transmission circuit comprises components and circuitry that extends a transmission distance of the calibration data to the air data computer (ADC).

50. The process of implementing and aircraft airflow sensor probe according to claim 33, further comprising providing at least one probe calibration transmission line, wherein the calibration data is transmitted via the at least one probe calibration transmission line.

51. The process of implementing and aircraft airflow sensor probe according to claim 50, further comprising providing at least one probe data reading transmission line implemented as an electrical transmission line.

52. The process of implementing and aircraft airflow sensor probe according to claim 50, further comprising providing at least one probe data reading transmission line implemented as pneumatic pressure transmission line.

53. The process of implementing and aircraft airflow sensor probe according to claim 33, wherein the calibration data memory is implemented as a volatile memory.

54. The process of implementing and aircraft airflow sensor probe according to claim 33, wherein the calibration data memory is implemented as a non-volatile memory (NVM).

55. The process of implementing and aircraft airflow sensor probe according to claim 33, wherein the calibration data memory is implemented as an electronically erasable and programmable read-only memory (EEPROM).

56. The process of implementing and aircraft airflow sensor probe according to claim 33, wherein the calibration data memory is configured to allow the air data computer (ADC) to download and/or otherwise obtain the calibration data from the aircraft airflow sensor probe.

57. The process of implementing and aircraft airflow sensor probe according to claim 33, wherein the calibration data memory is arranged within the aircraft airflow sensor probe in and/or on a calibration data circuit.
